(19) United States
(12) Patent Application Publication
(10) Pub. No.: US 2014/0141320 A1
(43) Pub. Date: May 22, 2014

(54) RECHARGEABLE BATTERY

(71) Applicant: SAMSUNG SDI CO., LTD., Yongin-si (KR)

(72) Inventor: Jae-Wook Lee, Yongin-si (KR)

(73) Assignee: SAMSUNG SDI CO., LTD., Yongin-si (KR)

(21) Appl. No.: 14/040,361

(22) Filed: Sep. 27, 2013

(30) Foreign Application Priority Data
Nov. 22, 2012 (KR) 10-2012-0133064

(51) Int. Cl. H01M 2/02

(52) U.S. Cl. CPC H01M 2/02; H01M 2/0202; H01M 2/0237
USPC 429/179

(57) ABSTRACT

A rechargeable battery having a structure that improves a strength of a case. The battery may include: case housing an electrode assembly; a cap plate covering an opening of the case; and an electrode terminal in a terminal hole of the cap plate and electrically connected to the electrode assembly. Here, the case has an opening at one side and includes: side walls connected to each other; a bottom connected to the side walls to close and seal a second side of the case opposite to the opening; and a reinforced portion at a corner of the side wall having a curved surface to increase a thickness of the corner.

### CROSS-REFERENCE TO RELATED APPLICATION

This application claims priority to and the benefit of Korean Patent Application No. 10-2012-0133064, filed in the Korean Intellectual Property Office on Nov. 22, 2012, the entire contents of which are incorporated herein by reference.

### BACKGROUND

1. Field

The embodiments of the present invention relate to a rechargeable battery having a high strength case.

2. Description of the Related Art

A rechargeable battery may repeatedly perform charge and discharge. A rechargeable battery having a small capacity may be used for a small portable electronic device, such as a mobile phone, a laptop computer, or a camcorder, and a rechargeable battery having a large capacity may be used as a power source in larger electronic devices, such as for driving a motor of an electric bicycle, a motor scooter, an electric vehicle, or a fork lift.

The rechargeable battery may include an electrode assembly that may be formed by stacking a positive electrode and a negative electrode with a separator interposed therebetween and by spiral-winding the stack into a jelly-roll form, a case that houses the electrode assembly together with an electrolyte solution, a cap plate that seals an upper end opening of the case, and an electrode terminal that is installed in the cap plate and that is electrically connected to the electrode assembly.

The case may be formed, for example, in a cylinder or a square shape using aluminum or an aluminum alloy. The case protects an electrode assembly from an external force and, thus, having a high strength is desirable. However, it is difficult to use a high-strength material due to restrictions to shaping methods.

The above information disclosed in this Background section is only for enhancement of understanding of the background of the described technology and therefore it may contain information that does not form the prior art that is already known in this country to a person of ordinary skill in the art.

### SUMMARY

Embodiments of the present invention provide a battery including a case with improved strength due to improved structural features.

An exemplary embodiment of the present invention provides a rechargeable battery, including: a case housing an electrode assembly; a cap plate covering an opening at one side of the case; and an electrode terminal in a terminal hole of the cap plate and electrically connected to the electrode assembly. Here, the case includes: side walls connected to each other; a bottom connected to the side walls to close and seal a second side of the case opposite to the opening; and a reinforced portion at a corner of the side walls. The reinforced portion may have a curved surface to increase a thickness of the corner.

The reinforced portion may extend to one of the side walls connected to the corner.

The side walls may include: a pair of long side walls opposite to each other; and a pair of short side walls opposite to each other and connected to corresponding ends of the long side walls. Here, the reinforced portion may extend to one of the short side walls at the corner.

An outer surface of the corner may have a first curvature radius, an inner surface of the corner may have a second curvature radius, and the first curvature radius may be smaller than the second curvature radius.

The long side walls may have a first thickness, the short side walls may have a second thickness, and the first thickness may be smaller than the second thickness.

The reinforced portion may include a bead protruding from an inner surface of the corner.

The side walls may include: a pair of long side walls opposite to each other; and a pair of short side walls opposite to each other and contacting corresponding ends of the long side walls. Here, the reinforced portion may extend to one of the short side walls at the corner and includes a bead protruding from an inner surface of the one of the short side walls.

The side walls and the bottom may include different kinds of materials.

A thickness of the bottom may be larger than that of the side walls.

According to an exemplary embodiment of the present invention, by forming a corner of a side wall in a curved surface and/or providing a reinforced portion at the corner, the strength of a case may be improved.

### BRIEF DESCRIPTION OF THE DRAWINGS

The above and other aspects and features of the present invention will become more apparent in view of the attached drawings and the accompanying detailed description.

FIG. 1 is an exploded perspective view illustrating a rechargeable battery according to a first exemplary embodiment of the present invention.

FIG. 2 is a cross-sectional view illustrating the rechargeable battery taken along the line II-II of FIG. 1.

FIG. 3 is a top plan view of a case according to the first exemplary embodiment.

FIG. 4 is a detailed view illustrating a corner of the case of FIG. 3.

FIG. 5 is a top plan view illustrating a case according to a second exemplary embodiment.

FIG. 6 is a detailed view illustrating a corner of the case of FIG. 5.

FIG. 7 is a detailed view illustrating a corner of the case according to a third exemplary embodiment.

FIG. 8 is a top plan view illustrating a case according to a fourth exemplary embodiment.

FIG. 9 is a cross-sectional view illustrating a case according to a fifth exemplary embodiment.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

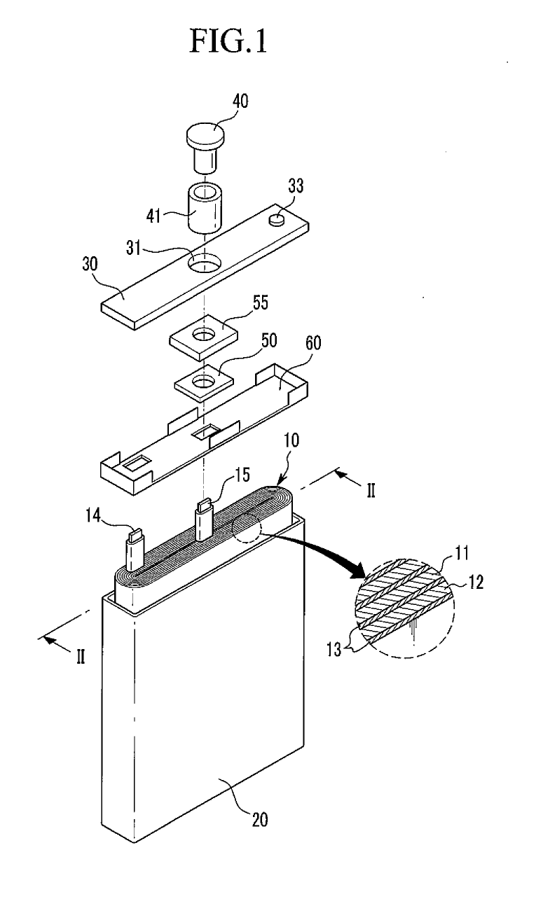

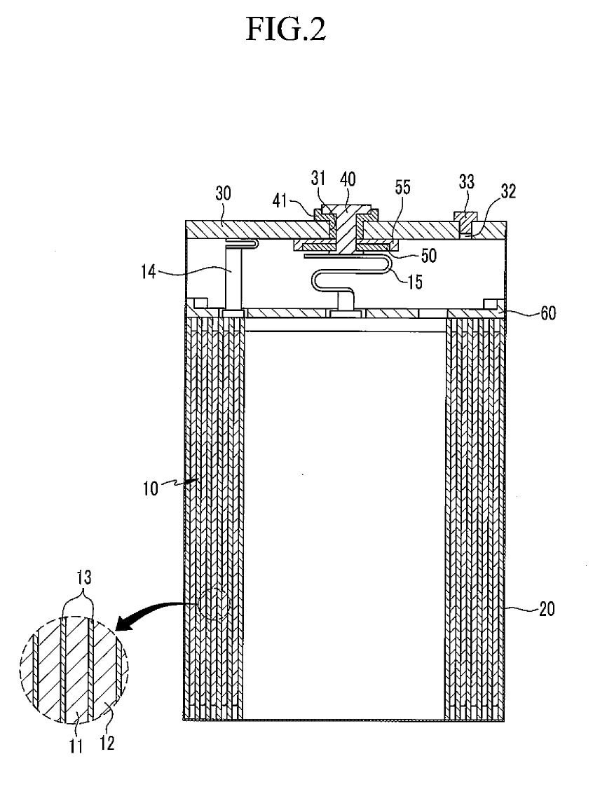

FIG. 1 is an exploded perspective view illustrating a rechargeable battery according to a first exemplary embodiment of the present invention, and FIG. 2 is a cross-sectional view illustrating the rechargeable battery taken along the line II-II of FIG. 1. Referring to FIGS. 1 and 2, the rechargeable battery of the first exemplary embodiment includes an electrode assembly 10 for charging and discharging a current, a case 20 that houses the electrode assembly 10 together with an electrolyte solution, a cap plate 30 that seals an upper end opening of the case 20, and an electrode terminal 40 that is installed (or located) in a terminal hole 31 of the cap plate 30 to be electrically connected to the electrode assembly 10.

Further, the rechargeable battery of the first exemplary embodiment may include a terminal plate 50 that electrically connects the electrode terminal 40 to the electrode assembly 10, and an insulation case 60 that electrically insulates the electrode assembly 10 and the cap plate 30.

The electrode assembly 10 has a shape corresponding to an internal space of the case (e.g., a square-shaped case) 20 in order to be inserted into the case 20. The case 20 houses the electrode assembly 10 through an opening and may be formed to be a conductor to perform an electrode terminal function. For example, the case 20 may be formed using aluminum or aluminum alloy.

The electrode assembly 10 may be formed by alternately stacking a positive electrode 11 and a negative electrode 12 with a separator 13, which is an electric insulating material, interposed therebetween, and by spiral-winding the stack in a jelly-roll form. The electrode assembly 10 includes a positive electrode lead 14 that is electrically connected to the positive electrode 11 and a negative electrode lead 15 that is electrically connected to the negative electrode 12.

The positive electrode lead 14 may be electrically connected to the cap plate 30 by welding the positive electrode lead 14 to a lower surface of the cap plate 30, and the case 20 is electrically connected to the positive electrode 11 of the electrode assembly 10 through the cap plate 30 to operate as a positive terminal.

The negative electrode lead 15 may be electrically connected to the terminal plate 50 by welding the negative electrode lead 15 to a lower surface of the terminal plate 50 that is electrically connected to one end of the electrode terminal 40, and the electrode terminal 40, which is in the terminal hole 31 of the cap plate 30, may be electrically connected to the negative electrode 12 of the electrode assembly 10 to operate as a negative terminal.

When the negative electrode lead 15 is electrically connected to the cap plate 30, the case 20 may operate as a negative terminal, and when the positive electrode lead 14 is electrically connected to the electrode terminal 40, the electrode terminal 40 may operate as the positive electrode lead.

The electrode terminal 40 is inserted into (or arranged in) the terminal hole 31 of the cap plate 30 with an insulation gasket 41 interposed therebetween. That is, the insulation gasket 41 may electrically insulate the terminal hole 31 from the electrode terminal 40 and may form a sealing structure between the terminal hole 31 and the electrode terminal 40.

The terminal plate 50 is electrically connected to the electrode terminal 40 with the insulation plate 55 interposed therebetween. That is, the insulation plate 55 may electrically insulate the cap plate 30 and the terminal plate 50 and may form a sealing structure between the cap plate 30 and the terminal plate 50.

The insulation case 60 is installed (or arranged) between the electrode assembly 10 and the terminal plate 50 to electrically insulate the positive electrode 11 of the electrode assembly 10 from the terminal plate 50, which may correspond to the negative electrode.

The cap plate 30 includes an electrolyte injection opening 32. The electrolyte injection opening 32 opens to the internal space of the case 20 and enables injection of an electrolyte solution into the case 20. After the electrolyte solution is injected, the electrolyte injection opening 32 is sealed by the seal stopper 33.

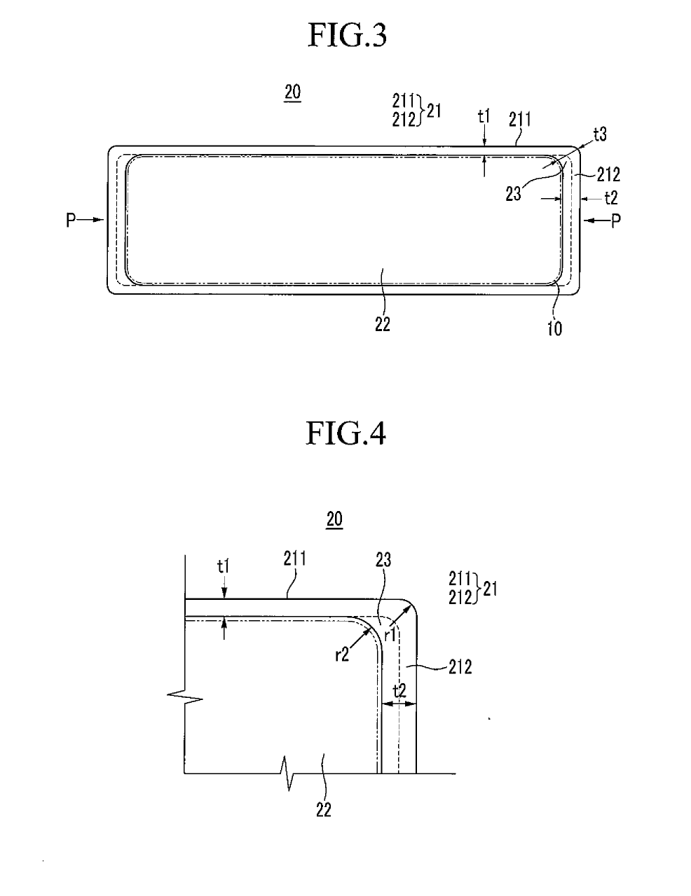

FIG. 3 is a top plan view of the case 20, and FIG. 4 is a detailed view illustrating a corner of the case 20 of FIG. 3. Referring to FIGS. 3 and 4, the case 20 includes a side wall 21, a bottom 22, and a reinforcing portion 23.

The side wall 21 is connected along a periphery to form an opening of the case 20 at one side, and the bottom 22 connects to the adjacent side wall 21 at a side opposite to the opening and closes and seals the side opposite to the opening.

According to an embodiment of the present invention, the reinforcing portion 23 is formed at a corner of the side wall 21, has a curved surface, and increases a thickness of the corner, thereby reinforcing the strength of the case 20 against a load P, which operates in a side direction of the case 20. The reinforcing portion 23 is further extended to the side wall 21 that is connected to the corner.

The side wall 21 may, for example, include a pair of long side walls 211 that are opposite to each other and a pair of short side walls 212 that connect both ends of the long side walls 211 and that are opposite to each other. As such, the side wall 21 may form a pipe of an approximate cuboid.

Here, the reinforcing portion 23 may further be extended to the short side wall 212 at a corner. Therefore, the reinforcing portion 23 reinforces the strength of the short side wall 212 and the corner to which the long side wall 211 and the short side wall 212 are connected, and reinforces the strength against a load P operating toward the short side wall 212, thereby reinforcing the strength of the entire case 20.

An outer surface of the corner to which the long side wall 211 and the short side wall 212 are connected may have a first curvature radius r1, an inner surface of the corner may have a second curvature radius r2. The first curvature radius r1 may be formed smaller than the second curvature radius r2 (r1<r2). That is, at the corner, because a curvature of the inner surface is larger than that of the outer surface, the reinforcing portion 23 is at the inner surface of the corner.

Further, the long side wall 211 may have a first thickness t1, and the short side wall 212 may have a second thickness t2. Because, according to an embodiment of the present invention, the reinforcing portion 23 is extended to the short side wall 212, the first thickness t1 is smaller than the second thickness t2. For example, the second thickness t2 may be from about 1.1 to about 5.0 times larger than the first thickness t1. According to an embodiment of the present invention, when the second thickness t1 is more than about 1.1 times smaller than the first thickness t1, the reinforcement strength may be unsatisfactory, and when the second thickness t1 is more than about 5.0 times larger than the first thickness t1, reception space of the electrode assembly 10 may be undesirably reduced.

The second thickness t2 may include a thickness of the reinforcing portion 23 that is in the short side wall 212. In this case, because the second curvature radius r2 of an inner surface of the corner is extended to the short side wall 212, a thickness gradually increases as advancing from the short side wall 212 to the corner, and a thickness gradually decreases as advancing from the corner to the long side wall 211.

Therefore, a load P operating toward the short side wall 212 of the case 20 is absorbed in the short side wall 212 and the reinforcing portion 23, and is transferred and distributed to the corner and the long side wall 211. That is, the case 20 has a reinforced strength against the load P operating toward the short side wall 212.

Because the reinforcing portion 23 forms an inner surface of the corner as a curved surface having the second curvature radius r2, the reinforcing portion 23 corresponds to a curved surface of the electrode assembly 10 and may not disturb reception of the electrode assembly 10 while reinforcing strength at the inside of the case 20.

Further, the reinforcing portion 23 may be arranged over a portion of an entire (or the entire) height range of the case 20 from an opening to the bottom 22. For example, when the reinforcing portion 23 is formed in a portion of the case, the reinforced portion 23 may be formed at the opening side of the case 20.

Hereinafter, various exemplary embodiments of the present invention will be illustrated. In a description of the following exemplary embodiments, elements identical to or corresponding to those of the first exemplary embodiment may be given by way of reference to the preceding description.

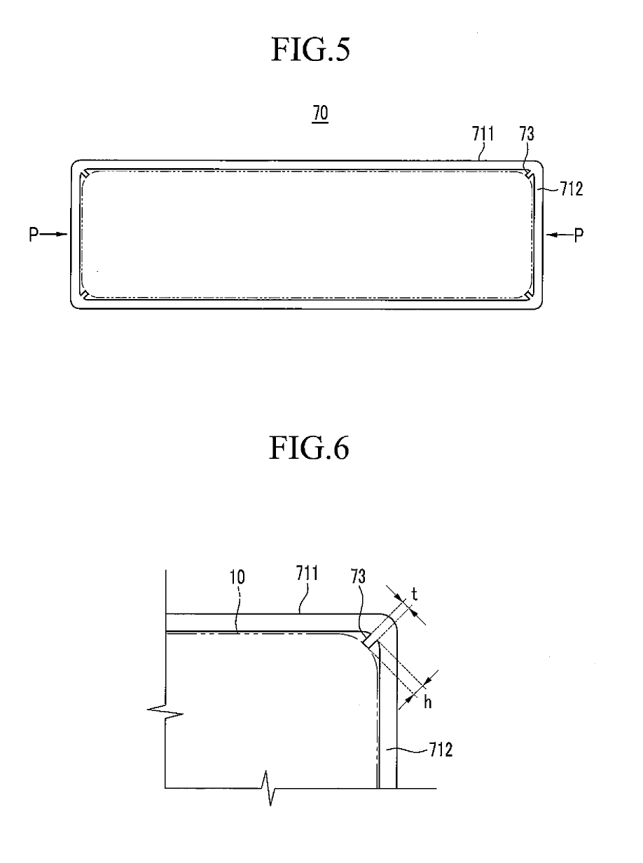

FIG. 5 is a top plan view illustrating a case 70 according to a second exemplary embodiment, and FIG. 6 is a detailed view illustrating a corner of the case 70 of FIG. 5. Referring to FIGS. 5 and 6, the case 70 has the same (or substantially the same) thickness in a long side wall 711 and a short side wall 712.

Here, a reinforced portion is formed with a bead 73 that protrudes from an inner surface of a corner. The bead 73 protrudes with a thickness t and a height h within a range that does not disturb reception of the electrode assembly 10 at an inner surface of the corner.

In an embodiment of the present invention, an angle that is set between the bead 73 and the long side wall 711 is the same (or substantially the same) as an angle that is set between the bead 73 and the short side wall 712. Therefore, a protruded height h of the bead 73 may be a height (e.g., a maximum height) that does not disturb reception of the electrode assembly 10, and thus, the strength of the case 70 is reinforced (e.g., maximally reinforced) within an allowance space of the corner.

Therefore, a load P operating toward the short side wall 712 of the case 70 is transferred and absorbed from the short side wall 712 to the bead 73. That is, the case 70 is reinforced against the load P operating toward the short side wall 712.

As described above, in the first exemplary embodiment, the reinforcing portion 23 is in the corner and the short side wall 212 to correspond (e.g., entirely correspond) to a curved surface of the electrode assembly 10. In contrast, the bead 73 of the second exemplary embodiment is formed at the corner to partially correspond to a curved surface of the electrode assembly 10.

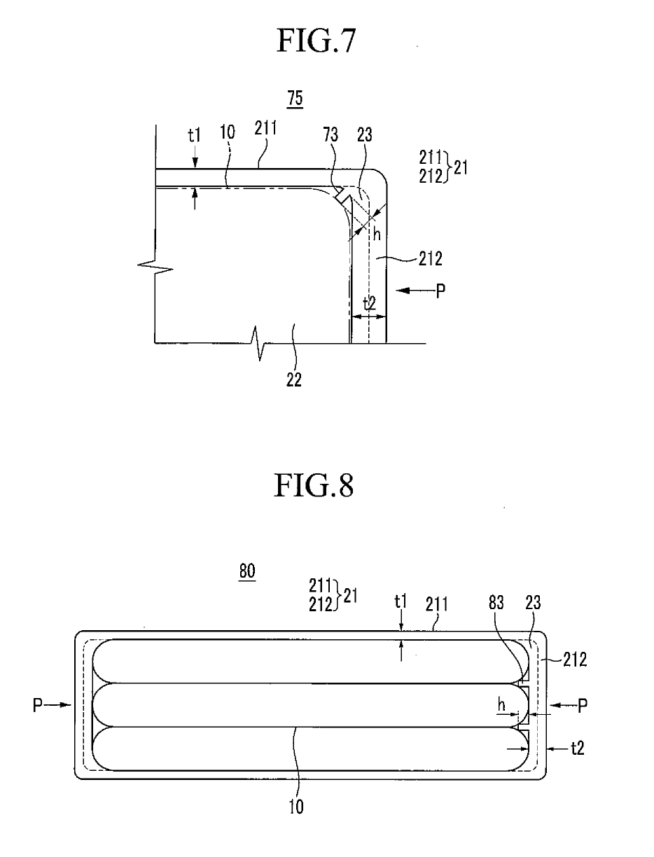

FIG. 7 is a detailed view illustrating a corner of a case 75 according to a third exemplary embodiment. Referring to FIG. 7, the case 75 includes a long side wall 211 with a first thickness t1 and a short side wall 212 with a second thickness t2, which is similar to the first exemplary embodiment.

A reinforcing portion 23 is at a corner and extends to the short side wall 212. Because the reinforcing portion 23 extends to the short side wall 212, the first thickness t1 is smaller than the second thickness t2. The second thickness t2 includes a thickness of the reinforcing portion 23 that is in the short side wall 212.

According to an embodiment of the present invention, the reinforcing portion 23 further includes a bead 73 that protrudes from an inner surface of the corner, similar to the second exemplary embodiment. Here, an angle that is set between the bead 73 and the long side wall 211 may be the same as an angle that is set between the bead 73 and the short side wall 212. Therefore, a protruded height h of the bead 73 may be at a height (e.g., a maximum height) that does not disturb reception of the electrode assembly 10. Accordingly, the strength of the case 75 may be reinforced (e.g., maximally reinforced) by the reinforcing portion 23 and the bead 73.

Therefore, a load P operating toward the short side wall 212 of the case 75 is transferred and absorbed from the short side wall 212 to the reinforcing portion 23 and the bead 73. That is, the case 75 is reinforced against the load P operating toward the short side wall 212.

FIG. 8 is a top plan view illustrating a case 80 according to a fourth exemplary embodiment. Referring to FIG. 8, the case 80 includes a long side wall 211 with a first thickness t1 and a short side wall 212 with a second thickness t2, which is similar to the first exemplary embodiment.

The reinforcing portion 23 may be formed at a corner and may extend to the short side wall 212 at the corner. Because the reinforcing portion 23 is extended to the short side wall 212, the first thickness t1 is smaller than the second thickness t2. The second thickness t2 further includes a thickness of the reinforcing portion 23 that is in the short side wall 212.

Further, according to an embodiment of the present invention, the reinforcing portion 23 includes a bead 83 that protrudes from an inner surface of the short side wall 212. In this case, the bead 83 may be located (e.g., arranged or disposed) between a plurality of electrode assemblies 10 and may have a height h that does not disturb reception of the electrode assemblies 10 while reinforcing strength of the case 80. The bead 83 may be formed to correspond to a space that is between the electrode assemblies 10. Accordingly, the strength of the case 80 is reinforced (e.g., maximally reinforced) by the reinforcing portion 23 and the bead 83.

Therefore, a load P operating toward the short side wall 212 of the case 80 is transferred and absorbed from the short side wall 212 to the reinforcing portion 23 and the bead 83. That is, the case 80 has reinforced strength for the load P operating toward the short side wall 212.

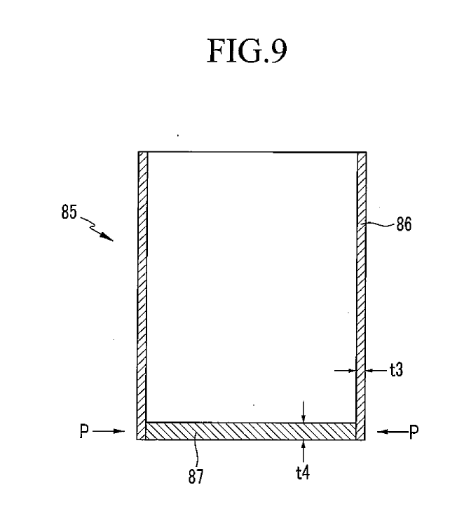

FIG. 9 is a cross-sectional view illustrating a case 85 according to a fifth exemplary embodiment. Referring to FIG. 9, a side wall 86 and a bottom 87 of the case 85 may be made of the same material or different kinds of materials. For example, the bottom 87 may be made of a material stronger than that of the side wall 86.

Additionally, the side wall 86 may be processed by extrusion shaping. The side wall 86 and the bottom 87 may be integrally shaped to form the case 85, e.g., by welding or impact extruding the bottom 87 to the side wall 86.

A thickness t4 of the bottom 87 may be larger than a thickness t3 of the side wall 86. For example, the thickness t4 may be from about 1.1 to about 5.0 times larger than the thickness t3. According to an embodiment of the present invention, when the fourth thickness t4 is more than about 1.1 times smaller than the third thickness t3, the reinforcement strength may be unsatisfactory, and when the fourth thickness t4 is more than about 5.0 times larger than the third thickness t3, a reception space of the electrode assembly 10 may be undesirably reduced.

Therefore, a load P operating at the side wall 86 of the case 85 is transferred and absorbed to the bottom 87. That is, the case 85 has reinforced strength against the load P operating in the side wall 87.

Further, in a structure of the case 85 of the fifth exemplary embodiment, when applying a reinforced structure of the first to fourth exemplary embodiments to the opening side, the case has further reinforced strength against the load P.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

Listing of Reference Numbers

| | |
|---|---|
| 10: electrode assembly | 11: positive electrode |
| 12: negative electrode | 13: separator |
| 14: positive electrode lead | 15: negative electrode lead |
| 20, 70, 75, 80: case | 21, 86: side wall |
| 22, 87: bottom | 23: reinforced portion |
| 30: cap plate | 31: terminal hole |
| 32: electrolyte injection opening | 33: seal stopper |
| 40: electrode terminal | 50: terminal plate |
| 55: insulation plate | 60: insulation case |
| 73, 83: bead | 211, 711: long side wall |
| 212, 712: short side wall | h: height |
| P: load | t, t3, t4: thickness |

r1, r2: first curvature radius and second curvature radius
t1, t2: first thickness and second thickness

What is claimed is:

1. A rechargeable battery, comprising:
a case housing an electrode assembly;
a cap plate covering an opening at one side of the case; and
an electrode terminal in a terminal hole of the cap plate and electrically connected to the electrode assembly,
wherein the case comprises:
side walls connected to each other;
a bottom connected to the side walls to close and seal a second side of the case opposite to the opening; and
a reinforced portion at a corner of the side walls.

2. The rechargeable battery of claim 1, wherein the reinforced portion has a curved surface to increase a thickness of the corner.

3. The rechargeable battery of claim 2, wherein the reinforced portion extends to one of the side walls connected to the corner.

4. The rechargeable battery of claim 3, wherein the side walls comprise:
a pair of long side walls opposite to each other; and
a pair of short side walls opposite to each other and connected to corresponding ends of the long side walls,
wherein the reinforced portion extends to one of the short side walls at the corner.

5. The rechargeable battery of claim 4,
wherein an outer surface of the corner has a first curvature radius,
wherein an inner surface of the corner has a second curvature radius, and
wherein the first curvature radius is smaller than the second curvature radius.

6. The rechargeable battery of claim 4,
wherein the long side walls have a first thickness,
wherein the short side walls have a second thickness, and
wherein the first thickness is smaller than the second thickness.

7. The rechargeable battery of claim 6, wherein the reinforced portion comprises a bead protruding from an inner surface of the corner.

8. The rechargeable battery of claim 2, wherein the side walls comprise:
a pair of long side walls opposite to each other; and
a pair of short side walls opposite to each other and contacting corresponding ends of the long side walls,
wherein the reinforced portion extends to one of the short side walls at the corner and comprises a bead protruding from an inner surface of the one of the short side walls.

9. The rechargeable battery of claim 1, wherein the reinforced portion comprises a bead protruding from an inner surface of the corner.

10. The rechargeable battery of claim 1, wherein the side walls and the bottom comprise different kinds of materials.

11. The rechargeable battery of claim 1, wherein a thickness of the bottom is larger than that of the side walls.
